(19) United States
(12) Patent Application Publication
(10) Pub. No.: US 2011/0039156 A1
(43) Pub. Date: Feb. 17, 2011

(54) CATHODE PLATE OF A LITHIUM ION BATTERY AND METHOD FOR MANUFACTURING THE SAME

(75) Inventors: Jian TU, Dongguan (CN); Tiegang ZHOU, Dongguan (CN); Houyong LI, Dongguan (CN); Kai WU, Dongguan (CN); Yuqun ZENG, Dongguan (CN)

Correspondence Address: BYIP, LTD., P.O. BOX 1484, GENERAL POST OFFICE, HONG KONG, HK

(73) Assignee: DONGGUAN AMPEREX TECHNOLOGY LIMITED, Dongguan (CN)

(21) Appl. No.: 12/854,184

(22) Filed: Aug. 11, 2010

(30) Foreign Application Priority Data
Aug. 11, 2009 (CN) 200910041784.1

(51) Int. Cl. H01M 4/583; H01M 4/62; B05D 5/12

(52) U.S. Cl. 429/217; 429/231.8; 429/212; 427/77; 977/742

(57) ABSTRACT

The present invention provides a cathode plate of a lithium ion battery. The cathode plate includes a carbon film cathode current collector and a cathode film containing cathode active material formed on the carbon film cathode current collector. The carbon film cathode current collector can remarkably improve the electrochemical performance and the safety performance of the lithium ion battery.

### CROSS-REFERENCE TO RELATED APPLICATION

The present patent application claims the benefit of Chinese Patent Application No. 200910041784.1, filed Aug. 11, 2009, the disclosure of which is hereby incorporated herein by reference in its entirety.

### FIELD OF THE INVENTION

The present invention generally relates to lithium ion batteries and, more particularly, to a cathode plate of a lithium ion battery and method for manufacturing the same.

### BACKGROUND OF THE INVENTION

Lithium ion batteries are widely used in various kinds of portable electronic devices for high energy density, long life span and high reliability.

Generally, a battery cell of a lithium ion battery includes an anode plate and a cathode plate spirally wound together with a separator disposed between the anode plate and the cathode plate. The cathode plate includes an aluminum cathode current collector and a cathode film containing cathode active material formed on the aluminum cathode current collector.

However, during the manufacturing process of the aluminum cathode current collector, particles is inevitably introduced, which will lead to internal short-circuit of the battery cell and further adversely affects the safety performance of the lithium ion battery. Additionally, when internal short circuit in the lithium ion battery occurs, contact of the anode plate and the cathode current collector will generate large current due to small resistance of the aluminum, which may lead to igniting, smoking or even exploding of the anode plate and further adversely affects the safety performance of the lithium ion battery.

What is needed, therefore, is to provide a cathode plate of a lithium ion battery having desirable safety performance and method of manufacturing the same.

### SUMMARY OF THE INVENTION

One object of the present invention is to provide a cathode plate of a lithium ion battery having desirable safety performance.

According to one embodiment of the present invention, a cathode plate of a lithium ion battery includes a carbon film cathode current collector and a cathode film containing cathode active material formed on the carbon film cathode current collector.

In accordance with one embodiment of the present invention, the carbon film cathode current collector can remarkably improve the electrochemical performance and the safety performance of the lithium ion battery.

Preferably, the carbon film cathode current collector contains conductive agent and binder.

Preferably, the carbon film cathode current collector contains 1 to 99 parts by weight of conductive agent and 0.1 to 90 parts by weight of binder.

Preferably, the conductive agent is selected from a group consisting of carbon black, carbon fiber, carbon nano-tube, aluminum flake and titanium flake.

Preferably, the binder is PVDF or PVDF-HFP copolymer.

Preferably, the carbon film cathode current collector contains a plasticizer selected from di-butyl phthalate, dimethyl phthalate or propylene carbonate.

Preferably, the carbon film cathode current collector contains 1 to 70 parts by weight of plasticizer.

The other object of the present invention is to provide a method for making a cathode plate of a lithium ion battery.

According to one embodiment of the present invention, a method for making a cathode plate of a lithium ion battery including the steps of: (a) dissolving a binder in a solvent and fully stiffing, obtaining a clear solution; (b) adding a conductive agent or mixture of a conductive agent and a plasticizer in the clear solution and fully stirring; (c) removing the solvent via evaporating and obtaining a carbon film; (d) drying the carbon film and adopting the dried carbon film as cathode current collector; and (e) preparing a cathode film and forming the cathode film on the carbon film cathode current collector via coating or hot pressing.

Preferably, the solvent in step (a) is acetone, n-methyl pyrrolidone or dimethyl sulfoxide.

Preferably, the conductive agent in step (b) is selected from a group consisting of carbon black, carbon fiber, carbon nano-tube, aluminum flake and titanium flake, the binder in step (a) is PVDF or PVDF-HFP copolymer, and the plasticizer in step (b) is di-butyl phthalate, dimethyl phthalate or propylene carbonate.

Other advantages and novel features will be drawn from the following detailed description of preferred embodiments with the attached drawings. The accompanying drawings, which are incorporated in and constitute a part of this specification, illustrate embodiments of the present invention and, together with a general description of the invention given above, and the detailed description of the embodiments given below, serve to explain the principles of the invention:

### BRIEF DESCRIPTION OF THE DRAWINGS

FIG. 1 shows the cycle life performance of a lithium ion battery according to example 1 of the present invention, charging at 0.5 C and discharging at 0.5 C at 25° C.;

FIG. 2 shows the cycle life performance of a lithium ion battery according to example 2 of the present invention, charging at 0.5 C and discharging at 0.5 C at 25° C.;

FIG. 3 shows the cycle life performance of a lithium ion battery according to example 3 of the present invention, charging at 0.5 C and discharging at 0.5 C at 25° C.;

FIG. 4 shows the cycle life performance of a lithium ion battery according to a comparative example, charging at 0.5 C and discharging at 0.5 C at 25° C.;

FIG. 5 shows voltage (v), temperature (° C.) vs. time (min) of a lithium ion battery according to example 1 of the present invention in the simulated nail penetration test; and

FIG. 6 shows voltage (v), temperature (° C.) vs. time (min) of a lithium ion battery according to the comparative example in the simulated nail penetration test.

### DETAILED DESCRIPTION OF THE INVENTION

To avoid adverse effect of aluminum cathode current collector on the safety performance of the lithium ion battery, the present invention adopts the carbon film as the cathode current collector. Preparation of the carbon film cathode current collector, the cathode film, the cathode plate and the lithium ion battery will be detailed with reference to the following examples, which are offered by way of illustration while not by way of limitation.

### EXAMPLES

### Example 1

Preparation of cathode current collector: dissolving organic binder copolymer of polyvinylidene fluoride and hexafluoropropylene (PVDF-HFP) in solvent acetone and fully stirring, obtaining clear solution which contains 10 parts by weight of the binder; adding plasticizer di-butyl phthalate (DBP) in the clear solution and obtaining a mixture solution; adding conductive agent carbon black Super-p in the mixture solution and fully stirring; removing the solvent acetone via evaporating and obtaining carbon film; and drying the carbon film and adopting the dried carbon film as the cathode current collector. The carbon film cathode current collector contains 30 parts by weight of PVDF-HFP, 50 parts by weight of carbon black Super-p and 20 parts by weight of DBP.

Preparation of the cathode film: adding lithium cobalt oxide, carbon black Super-p and PVDF-HFP in the weight ratio of 95.0:3.0:2.0 in the mixture of acetone and DBP and fully stiffing, obtaining the cathode paste; and coating the cathode paste on the surface of polyester film having the thickness of 30 μm and drying, obtaining the cathode film.

Preparation of the cathode plate: shearing the cathode film to a predetermined size and shape; and forming the sized and shaped cathode film on the carbon film cathode current collector as previously detailed via hot pressing, obtaining the cathode plate.

Preparation of the anode plate: adding graphite, DBP, carbon black Super-p and PVDF-HFP in the weight ratio of 95.5:1.5:1.5:1.5 in acetone and fully stirring, obtaining the anode paste; coating the anode paste on the surface of polyester film having thickness of 30 μm and drying, obtaining the anode film; shearing the anode film to a predetermined size and shape; and forming the seized and shaped anode film on copper anode current collector via hot pressing, obtaining the anode plate.

Preparation of the lithium ion battery: stacking or winding the cathode plate, the anode plate as previously detailed with the separator of PP/PE/PP disposed between the cathode plate and the anode plate, obtaining a battery cell; removing the plasticizer in the battery cell via evaporating; accommodating the battery cell in a can housing of steel; and adding the electrolyte in the can housing, obtaining the lithium ion battery. In the present example, the slat in the electrolyte is LiPF₆. The solvent contains 20 parts by weight of ethylene carbonate, 30 parts by weight of methyl ethyl carbonate, and 50 parts by weight of dimethyl carbonate.

Test the capacities of a number of samples according to lithium ion batteries of example 1. The results are shown in table 1.

TABLE 1
Capacities of the lithium ion batteries of example 1

| Serial of the sample | Charge/discharge rate | Capacity (mAh) |
|---|---|---|
| 1 | 0.5 C/0.5 C | 1002 |
| 2 | 0.5 C/0.5 C | 1008 |
| 3 | 0.5 C/0.5 C | 1006 |
| 4 | 0.5 C/0.5 C | 1001 |
| 5 | 0.5 C/0.5 C | 1013 |
| 6 | 0.5 C/0.5 C | 1007 |

### Example 2

Preparation of the cathode current collector: dissolving polymer binder polyvinylidene fluoride (PVDF) in solvent n-methyl-2-pyrrolidone (NMP) and fully stiffing and dissolving, obtaining clear solution containing 8 parts by weight of PVDF; adding mixture conductive agent carbon black Super-p and carbon fiber (CF) in the clear solution and fully stirring; removing the solvent NMP via evaporating and obtaining carbon film; and drying the carbon film and adopting the dried carbon film as the cathode current collector. In the present example, the weight ratio of PVDF to the mixture conductive agent is 40:60. The mixture conductive agent contains 45 parts by weight of carbon black Super-p and 55 parts by weight of carbon fiber.

Preparation of the cathode film, the cathode plate, the anode plate and the lithium ion battery are the same as has been described in detail in Example 1.

Test the capacities of a number of samples according to lithium ion batteries of example 2. The results are shown in table 2.

TABLE 2
the capacities of the lithium ion batteries of example 2

| Serial of the sample | Charge/discharge rate | Capacity (mAh) |
|---|---|---|
| 1 | 0.5 C/0.5 C | 1006 |
| 2 | 0.5 C/0.5 C | 1007 |
| 3 | 0.5 C/0.5 C | 1011 |
| 4 | 0.5 C/0.5 C | 1014 |
| 5 | 0.5 C/0.5 C | 1004 |
| 6 | 0.5 C/0.5 C | 1006 |

### Example 3

Preparation of the cathode current collector: dissolving copolymer PVDF-HFP in acetone solvent and fully stiffing, obtaining clear solution containing 1 to 20 parts by weight of copolymer PVDF-HFP; adding plasticizer DBP and conductive agent carbon nano-tube in the clear solution and fully stirring; removing the acetone solvent via evaporating, obtaining carbon film; and drying the carbon film and adopting the dried carbon film as the cathode current collector. The carbon film cathode current collector contains 60 parts by weight of carbon nano-tube, 25 parts by weight of PVDF-HFP, and 15 parts by weight of DBP.

Preparation of the cathode film, the cathode plate, the anode plate and the lithium ion battery are the same as has been described in detail in Example 1.

Test the capacities of a number of samples according to lithium ion batteries of example 3. The results are shown in table 3.

TABLE 3
Capacities of the lithium ion batteries of example 3

| Serial of the samples | Charge/discharge rate | Capacity (mAh) |
|---|---|---|
| 1 | 0.5 C/0.5 C | 1005 |
| 2 | 0.5 C/0.5 C | 1008 |
| 3 | 0.5 C/0.5 C | 1010 |
| 4 | 0.5 C/0.5 C | 1015 |
| 5 | 0.5 C/0.5 C | 1007 |
| 6 | 0.5 C/0.5 C | 1006 |

It is understandable that, in accordance with an alternative embodiment of the present invention, the conductive agent in the carbon film cathode current collector can be selected from a group consisting of carbon black, carbon fiber, carbon nano-tube, aluminum flake and titanium flake. The binder can be PVDF-HFP copolymer or PVDF. The plasticizer can be DBP, dimethyl phthalate (DMP) or propylene carbonate (PC). Additionally, the solid content of the conductive agent, the binder and the plasticizer in the carbon film cathode current collector can be 1 to 99 parts by weight, 0.1 to 90 parts by weight and 1 to 70 parts by weight, respectively. The solvent can be selected from acetone, NMP or dimethyl sulfoxide (DMSO). The cathode film also can be formed on the carbon film cathode current collector via hot pressing or coating.

### Comparative Example

Referring to table 4, for more clearly showing the technical effects of the present invention, the capacities of the lithium ion battery according to a comparative example are listed below. In the comparative example, the lithium ion battery adopts conventional aluminum foil having thickness of 16 μm as the cathode current collector. Preparation of the cathode film, the anode film and the lithium ion battery are the same as has been detailed in example 1.

Similar to example 1 to example 3 of the present invention, test the capacities of a number of samples according to the lithium ion battery of the comparative example. The results are shown in table 4.

TABLE 4
Capacities of the lithium ion batteries of comparative example

| Serial of the samples | Charge/discharge rate | Capacity (mAh) |
|---|---|---|
| 1 | 0.5 C/0.5 C | 1000 |
| 2 | 0.5 C/0.5 C | 1012 |
| 3 | 0.5 C/0.5 C | 1010 |
| 4 | 0.5 C/0.5 C | 1008 |
| 5 | 0.5 C/0.5 C | 1006 |
| 6 | 0.5 C/0.5 C | 1003 |

Via the comparison of table 1 to table 4, it is clearly shown that the lithium ion batteries in examples 1 to 3 of the present invention almost have the same capacity as the lithium ion battery of the comparative example.

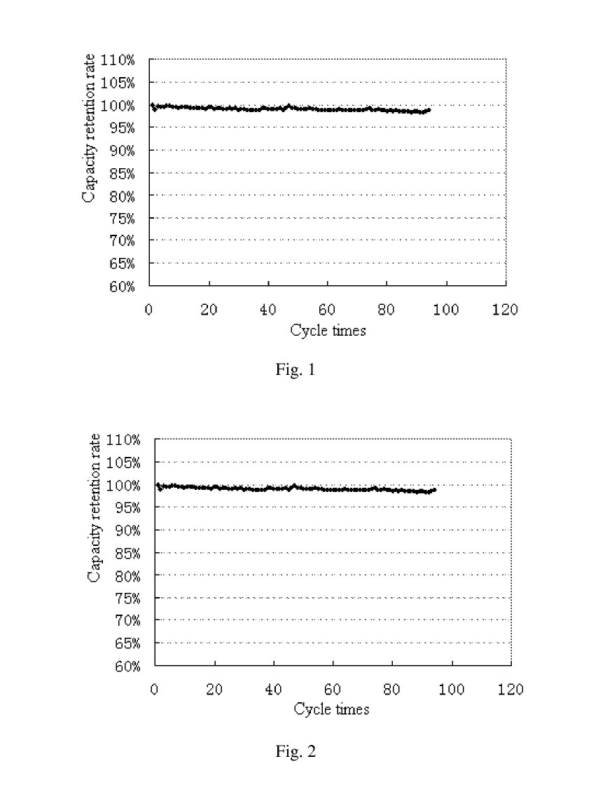

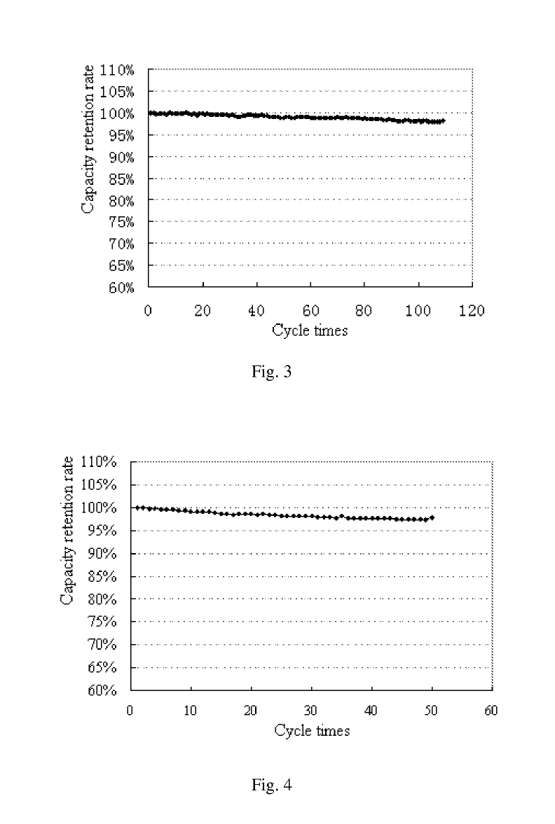

Referring to FIG. 1 to FIG. 4, it is clearly shown that the lithium ion batteries according to example 1 to example 3 of the present invention have desirable cycle life performance charging at 0.5 C and discharging at 0.5 C at 25° C.

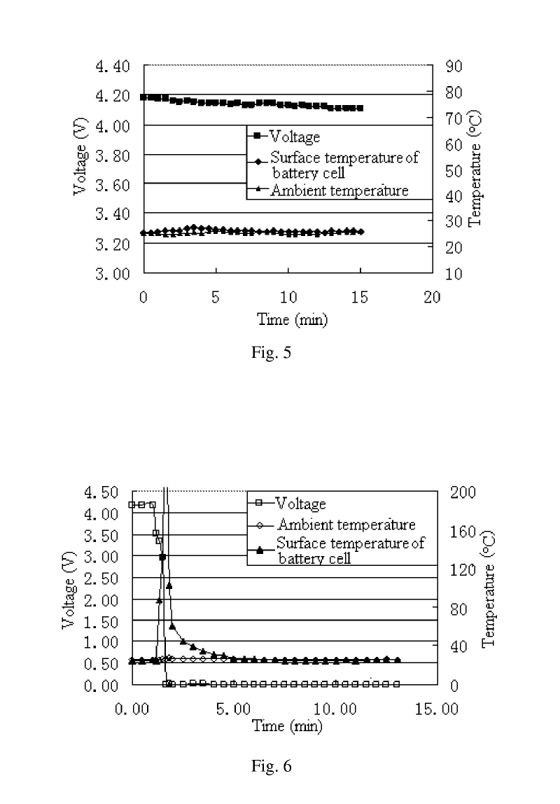

Referring to FIG. 5 and FIG. 6, except for the desirable cycle life performance, the lithium ion batteries according to the examples of the present invention also has desirable safety performance. According to the simulated nail penetration test results as shown in FIG. 5 and FIG. 6, when internal short circuit occurs in the lithium ion battery which adopts the conventional aluminum cathode current collector of comparative example, the voltage decreases to about 0V rapidly. However, there is no obvious surface temperature increase in the lithium ion battery of example 1 of the present invention which adopts the carbon film as the cathode current collector. The battery cell of the lithium ion battery of example 1 does not ignite or smoke.

In view of the above description, it is clearly shown that the lithium ion batteries according to the present invention which adopt carbon film as the cathode current collector can remarkably improve the safety performance and electrochemical performance of the lithium ion batteries.

While the present invention has been illustrated by the above description of the preferred embodiments thereof, while the preferred embodiments have been described in considerable detail, it is not intended to restrict or in any way to limit the scope of the appended claims to such details. Additional advantages and modifications within the spirit and scope of the present invention will readily appear to those ordinary skilled in the art. Consequently, the present invention is not limited to the specific details and the illustrative examples as shown and described.

What is claimed is:

1. A cathode plate of a lithium ion battery, comprising: a carbon film cathode current collector and a cathode film containing cathode active material formed on the carbon film cathode current collector.

2. The cathode plate of claim 1, wherein the carbon film cathode current collector contains conductive agent and binder.

3. The cathode plate of claim 2, wherein the solid carbon film cathode current collector contains 1 to 99 parts by weight of conductive agent and 0.1 to 90 parts by weight of binder.

4. The cathode plate of claim 2, wherein the conductive agent is selected from a group consisting of carbon black, carbon fiber, carbon nano-tube, aluminum flake and titanium flake.

5. The cathode plate of claim 2, wherein the binder is PVDF or PVDF-HFP copolymer.

6. The cathode plate of claim 2, wherein the carbon film cathode current collector further contains plasticizer selected from di-butyl phthalate, dimethyl phthalate or propylene carbonate.

7. The cathode plate of claim 6, wherein the carbon film cathode current collector contains 1 to 70 parts by weight of plasticizer.

8. A method for manufacturing a cathode plate of a lithium ion battery, comprising the steps of:
(a) dissolving a binder in a solvent and fully stiffing, obtaining a clear solution;
(b) adding conductive agent or mixture of conductive agent and plasticizer in the clear solution and fully stirring;
(c) removing the solvent via evaporating and obtaining carbon film;
(d) drying the carbon film and adopting the dried carbon film as the cathode current collector; and
(e) preparing a cathode film and forming the cathode film on the carbon film cathode current collector via coating or hot pressing.

9. The method of claim 8, wherein the solvent in step (a) is acetone, n-methyl pyrrolidone or dimethyl sulfoxide.

10. The method of claim 8, wherein the conductive agent in step (b) is selected from a group consisting of carbon black, carbon fiber, carbon nano-tube, aluminum flake and titanium flake, the binder in step (a) is PVDF or PVDF-HFP copolymer, and the plasticizer in step (b) is di-butyl phthalate, dimethyl phthalate or propylene carbonate.
